(19) United States
(12) Patent Application Publication
(10) Pub. No.: US 2005/0117264 A1
(43) Pub. Date: Jun. 2, 2005

(54) Ground fault circuit interrupter

(76) Inventor: Victor V. Aromin, West Warwick, RI (US)

Correspondence Address: KRIEGSMAN & KRIEGSMAN, 665 Franklin Street, Framingham, MA, 01702, US

(21) Appl. No.: 10/972,080

(22) Filed: Oct. 22, 2004

Related U.S. Application Data
(60) Provisional application No. 60/513,469, filed on Oct. 22, 2003.

(51) Int. Cl. H02H 3/00

(52) U.S. Cl. 361/42

(57) ABSTRACT

A ground fault circuit interrupter (GFCI) for use with a power cable which connects a power source to a load. The GFCI includes first and second pairs of terminals which are located at opposite ends of the power cable, the first pair of terminals being designated for connection with the power source and the second pair of terminals being designated for connection with the load. A pair of electrical outlets are connected to the power cable at a location between the first and second pairs of terminals. A first circuit breaker is located in the power cable between the pair of electrical outlets and the second pair of terminals. A ground fault detection circuit detects the presence of a ground fault condition in the power cable and, in turn, generates a trip signal which is used to energize a solenoid that is ganged to the first circuit breaker. In one embodiment, a second circuit breaker is located in the power cable between the first pair of terminals and the pair of electrical outlets, the second circuit breaker being ganged to the first circuit breaker. In this manner, the GFCI provides ground fault protection regardless of whether the power source is connected to the first or second pairs of terminals. In another embodiment, a reverse wiring circuit is provided which generates an artificial ground fault condition when the power source is improperly connected to the second pair of terminals rather than the first pair of terminals.

### CROSS-REFERENCE TO RELATED APPLICATIONS

The present application claims the benefit under 35 U.S.C. 119(e) of U.S. provisional Patent Application Ser. No. 60/513,469, filed Oct. 22, 2003, the disclosure of which is incorporated herein by reference.

### BACKGROUND OF THE INVENTION

The present invention relates generally to electrical safety devices and more particularly to ground fault circuit interrupters (GFCIs).

Alternating current (AC) power is typically delivered from a power source (e.g., a power plant) to a load (e.g., an electrical appliance plugged into a conventional electrical outlet) through a network of interconnected power cables, each power cable comprising a pair of conducting lines. Specifically, each power cable typically comprises a hot line (which is also commonly referred to in the art as a hot wire or a power line) and a neutral line (which is also commonly referred to in the art as a neutral wire).

The hot line is provided with a first end and a second end. The first end of the hot line (which is commonly referred to in the art as its line end) leads to a high energy source located at the power source. The second end of the hot line (which is commonly referred to in the art as its load end) leads to a load connected thereto.

Similarly, the neutral line is provided with a first end and a second end. The first end of the neutral line (which is commonly referred to in the art as its line end) leads to an electrically neutral source that is located at the power source. The second end of the neutral line (which is commonly referred to in the art as its load end) leads to the load connected thereto.

With the line end of each conductive line connected to a power source and with the load end of each conductive line connected to a load, a closed circuit is effectively created. Because the hot line connects to a high energy source and the neutral line connects to an electrically neutral source, a voltage is created across the circuit which, in turn, serves to power the load. When the closed circuit is operating properly, the current which flows through the hot line is equal to the current which flows through the neutral line.

However, it has been found that, on occasion, the hot line can connect directly to ground (e.g., if someone who is grounded accidentally touches the hot line). The connection of the hot line directly to ground causes the current flowing therethrough to drop, thereby establishing unequal current levels through the hot line and the neutral line. In response to the imbalance of currents flowing through the hot and neutral lines, the closed circuit will naturally adjust the current flow through the hot line to equal the current flow through the neutral line. This adjustment is accomplished through a rapid surge in the current level through the hot line (to a level which is equal to the current level through the neutral line). The resulting surge of electricity through the hot line (commonly referred to in the art as a ground fault condition) can potentially harm an individual who is operating the at the time of the current surge.

Accordingly, ground fault circuit interrupters are well known in the art and are widely used in commerce to protect against ground fault conditions (i.e., by opening the closed circuit). Examples of ground fault circuit interrupters are found in U.S. Pat. No. 6,052,266 to V. Aromin and U.S. Pat. No. 5,757,598 to V. Aromin, both of which are incorporated herein by reference.

One type of ground fault circuit interrupter (GFCI) which is well known in the art is provided with a pair of electrical outlets which can be used to power most types of conventional electrical appliances. This type of GFCI is typically installed directly into an electrical box which is, in turn, mounted within a bathroom or kitchen wall, this type of GFCI being commonly referred to as a wall mountable GFCI in the art. As such, wall mountable GFCIs serve two principal functions: (1) to provide a pair of electrical outlets for powering conventional electrical appliances (e.g., hair dryers, toasters, microwaves, etc.) and (2) to trip open the closed circuit upon detecting a ground fault condition in the power cable which, in turn, quickly terminates the flow of electricity (and, most importantly, the flow of any surge in current) into the load and both of the electrical outlets.

A ground fault circuit interrupter (GFCI) commonly includes a differential transformer with opposed primary windings, one primary winding being associated with the power line and the other primary winding being associated with the neutral line. If a ground fault condition should occur on the load side of the GFCI, the two primary windings will no longer cancel, thereby producing a flux flow in the core of the differential transformer. This resultant flux flow is detected by a secondary winding wrapped around the differential transformer core. In response thereto, the secondary winding produces a trip signal which, in turn, is used to open a switch located in at least one of the conducting lines between the power supply and the load (as well as between the power supply and the pair of electrical outlets), thereby eliminating the dangerous condition.

A ground fault circuit interrupter is traditionally constructed to include an exterior casing which is constructed out of a non-conductive material, such as plastic. Disposed within said casing is the ground fault circuit electronics (which are commonly mounted on a single double-sided printed circuit board). As noted above, a pair of electrical outlets are commonly integrated into the exterior casing and in electrical connection with the ground fault circuit electronics.

It should be noted that a plurality of conductive terminals are coupled to the ground fault circuit electronics and are externally accessible through small openings in the exterior casing, these conductive terminals serving as the point of connection for the GFCI to the power source and the load. In particular, the GFCI is provided with a pair of line side terminals, one of the terminals being designated for connection to the cable which leads to the hot line of the power source and the other terminal being designated for connection to the cable which leads to the neutral line of the power source. In addition, the GFCI is provided with a pair of load side terminals, one of the terminals being designated for connection to the cable which leads to the hot line of the load and the other terminal being designated for connection to the cable which leads to the neutral line of the load. Furthermore, the GFCI is often provided with a single grounding terminal (often marked in green to facilitate its identification) which is designated for connection to ground.

In U.S. Pat. No. 5,757,598, to V.V. Aromin, there is disclosed an example of a ground fault circuit interrupter (GFCI) which protects against ground fault conditions present in a power cord that extends between a source of power and a load. The GFCI includes a circuit breaker having a switch located in one of the pair of the lines. The switch has a first position in which the source of power in its associated line is not connected to the load and a second position in which the source of power in its associated line is connected to the load. A relay circuit is coupled to the switch for selectively positioning the switch in either the first or second position. The relay circuit includes a solenoid which operates in either an energized or a de-energized state. When energized, the solenoid positions the switch in its second position and when de-energized, the solenoid positions the switch in its first position. The GFCI also includes a booster circuit for selectively supplying a first voltage through the switch and to the solenoid which is sufficient to cause the solenoid to switch from its de-energized state to its energized state. A power supply circuit supplies a second voltage to the solenoid which is less than the first voltage. The second voltage is sufficient to maintain the solenoid in its energized state after being initially energized by the first voltage but is insufficient to switch the solenoid from its de-energized state to its energized state. A latch circuit operable in first and second bi-stable states allows the solenoid to switch from its de-energized state to its energized state and remain in its energized state when in its first bi-stable state and allowing solenoid to switch from its energized state to its de-energized state and remain in its de-energized state when in its second bi-stable state. A fault detection circuit detects the presence of a fault condition in at least one of the lines extending between the power and the load and causes the latch circuit to latch in its second bi-stable state upon detection of the fault condition.

While GFCIs of the type described above are well known in the art and widely used in commerce to protect electrical appliances from ground fault conditions, it has been found that these types of GFCIs suffer from a notable shortcoming.

Specifically, GFCIs of the type described above are typically designed to provide ground fault protection in only one direction (i.e., in the direction from terminals designated for connection to the power source to the terminals designated for connection to the load). As a result, GFCIs of the type described above are only capable of providing ground fault protection to its pair of electrical outlets as well as the load coupled thereto if the power source and load are connected to their designated terminals on the GFCI.

However, it has been found that, on occasion, consumers incorrectly connect the line and load side cables to the ground fault circuit interrupter. Specifically, consumers often inadvertently connect the cables leading to the power source (i.e., the line side cables) to the load side terminals on the GFCI and the cables leading to the load (i.e., the load side cables) to the line side terminals on the GFCI. This inadvertent mistake in the connection of the line and load side cables to the GFCI still serves to electrically connect the line to the load and, as a consequence, supply voltage to the load. In addition, this inadvertent mistake in connection still affords the load connected to the line side terminals of the GFCI with ground fault protection. However, this inadvertent mistake in connection precludes the electrical outlets which are integrated into the GFCI from providing ground fault protection. As a result of this common wiring mistake, a consumer who utilizes an electrical appliance that is plugged into one of the electrical outlets of the GFCI is rendered highly susceptible to the risk of a shock hazard, which is highly undesirable.

It is important to note that the consumer would not become aware of the aforementioned mistake in wiring because power would still be delivered to the load as well as to both electrical outlets. In addition, GFCIs which include test and reset buttons would function as if the GFCI were properly wired. As such, the user would believe that the GFCI is providing ground fault protection to the pair of electrical outlets when, in fact, no ground fault protection is actually being provided to the outlets.

### SUMMARY OF THE INVENTION

It is an object of the present invention to provide a new and improved ground fault circuit interrupter (GFCI) which protects against ground fault conditions present in the hot and neutral lines of a power cable that connects a power source to a load.

It is another object of the present invention to provide a GFCI of the type described above which includes a first pair of conductive terminals which are designated for connection to the power source and a second pair of conductive terminals which are designated for connection to the load.

It is yet another object of the present invention to provide a GFCI of the type described above which includes a pair of electrical outlets.

It is yet another object of the present invention to provide a GFCI of the type described above which offers ground fault protection to the pair of electrical outlets in more than one direction.

It is yet another object of the present invention to provide a GFCI as described above which may be mass produced, has a minimal number of parts, and can be easily assembled.

Accordingly, in one embodiment of the present invention, there is provided a ground fault circuit interrupter (GFCI) for use with a power cable, the power cable being designed to connect a power source with a load, the power cable comprising at least a hot line and a neutral line, the ground fault circuit interrupter comprising a first pair of terminals located at one end of the power cable, a second pair of terminals located at the other end of the power cable, an electrical outlet connected to the power cable at a location between the first and second pairs of terminals, a first circuit breaker having a first switch, the first switch being located in one of the lines of the power cable between the first pair of terminals and the electrical outlet, the first switch having an open position and a closed position, a second circuit breaker having a second switch, the second switch being located in one of the lines of the power cable between the electrical outlet and the second pair of terminals, the second switch having an open position and a closed position, the first and second switches being ganged together, a relay circuit for selectively moving and maintaining each of the first and second switches in either its open position or its closed position, and a ground fault detection circuit for detecting the presence of a ground fault condition in the power cable between the first and second pairs of terminals, the ground fault detection circuit providing a trip signal upon detecting a ground fault condition in the power cable, the relay circuit moving and maintaining each of the first and second switches in its open position in response to the trip signal.

In another embodiment of the present invention, there is provided a ground fault circuit interrupter (GFCI) for use with a power cable, the power cable being designed to connect a power source with a load, the power cable comprising at least a hot line and a neutral line, the ground fault circuit interrupter comprising a first pair of terminals located at one end of the power cable, the first pair of terminals being designated for connection to the power source, a second pair of terminals located at the other end of the power cable, the second pair of terminals being designated for connection to the load, an electrical outlet connected to the power cable at a location between the first and second pairs of terminals, a circuit breaker having a first switch, the first switch being located in one of the lines of the power cable between the first pair of terminals and the electrical outlet, the first switch having an open position and a closed position, a relay circuit for selectively moving and maintaining the first switch in either its open position or its closed position, a reverse wiring circuit for generating an artificial ground fault condition when the power source is connected to the second pair of terminals, and a ground fault detection circuit for detecting the presence of either a ground fault condition in the power cable between the first and second pairs of terminals or an artificial ground fault condition generated by the reverse wiring circuit, the ground fault detection circuit providing a trip signal upon detecting either the ground fault condition or the artificial ground fault condition, the relay circuit moving and maintaining the first switch in its open position in response to the trip signal.

Additional objects, as well as features and advantages, of the present invention will be set forth in part in the description which follows, and in part will be obvious from the description or may be learned by practice of the invention. In the description, reference is made to the accompanying drawings which form a part thereof and in which is shown by way of illustration specific embodiments for practicing the invention. These embodiments will be described in sufficient detail to enable those skilled in the art to practice the invention, and it is to be understood that other embodiments may be utilized and that structural changes may be made without departing from the scope of the invention. The following detailed description is, therefore, not to be taken in a limiting sense, and the scope of the present invention is best defined by the appended claims.

### BRIEF DESCRIPTION OF THE DRAWINGS

The accompanying drawings, which are hereby incorporated into and constitute a part of this specification, illustrate various embodiments of the invention and, together with the description, serve to explain the principles of the invention. In the drawings wherein like reference numerals represent like parts:

FIG. 1 is a front plan view of a prior art ground fault circuit interrupter;

FIG. 2 is a rear plan view of the prior art ground fault circuit interrupter which is shown in FIG. 1;

FIG. 3 is an electrical schematic of the prior art ground fault circuit interrupter which is shown in FIG. 1;

FIG. 4 is a first embodiment of a ground fault circuit interrupter constructed according to the teachings of the present invention;

FIG. 5 is a second embodiment of a ground fault circuit interrupter constructed according to the teachings of the present invention; and

FIG. 6 is a third embodiment of a ground fault circuit interrupter constructed according to the teachings of the present invention.

### DETAILED DESCRIPTION OF PREFERRED EMBODIMENTS

Referring now to FIGS. 1-3, there is shown a prior art ground fault circuit interrupter (GFCI) which is identified generally by reference numeral 11. GFCI 11 is designed principally for use as a safety device for a power cable P (also referred to herein as a power cord) which connects a line (also referred to herein as a power source) to a load (e.g., an electric appliance), the power cable P comprising a hot line H, a neutral line N and a ground line G. As will be described further below, prior art GFCI 11 provides protection against ground fault conditions present in the power cable.

GFCI 11 is provided with an exterior casing 13 which is constructed out of a non-conductive material such as plastic. Casing 13 has a generally box-shaped design and includes a flat front surface 15, a flat rear surface 17, a top surface 19, a bottom surface 21, a right side surface 23 and a left side surface 25. Casing 13 is preferably constructed out of two separately molded pieces which are then secured together (e.g., through a snap-fit interconnection) during a subsequent manufacturing process.

GFCI 11 includes a pair of metal brackets 27, one bracket 27-1 extending at an approximate right angle relative to top surface 19 and the other bracket 27-2 extending at an approximate right angle relative to bottom surface 21. Together, brackets 27 enable GFCI 11 to be installed into a conventional electrical box which, in turn, is fixedly disposed within a bathroom or kitchen wall. For this reason, GFCI 11 is commonly referred to as a wall mountable ground fault circuit interrupter in the art.

As seen most clearly in FIG. 1, front surface 15 at least partially defines a pair of standard electrical outlets 29, wherein a top outlet 29-1 is positioned directly above a bottom outlet 29-2. It should be noted that a plurality of differently shaped openings 31-1, 31-2 and 31-3 are formed in front surface 15, each opening 31 providing access to a corresponding conductive terminal for outlet 29, as will be described further below.

An externally accessible test button 33 and an externally accessible reset button 35 project through corresponding openings formed in front surface 15. Buttons 33 and 35 are coupled to associated switches which are located inside casing 13 (as will be described further below) and can be used to perform selected operations for GFCI 11.

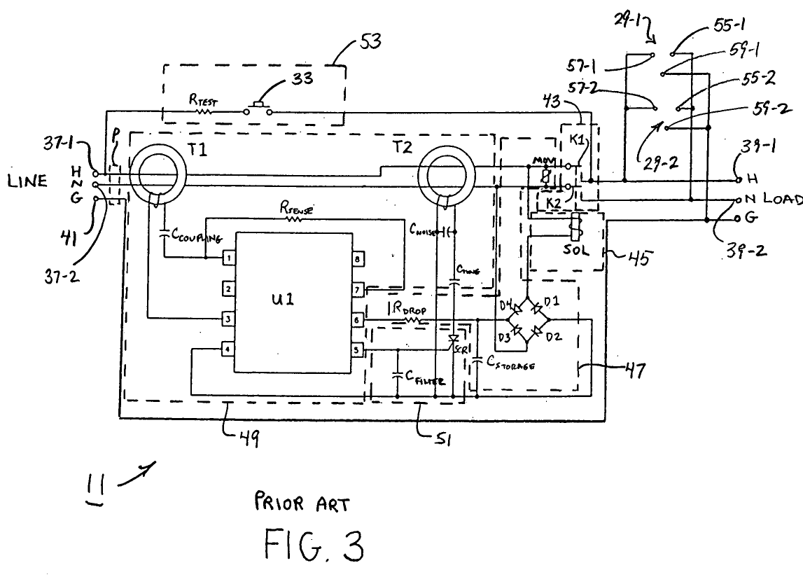

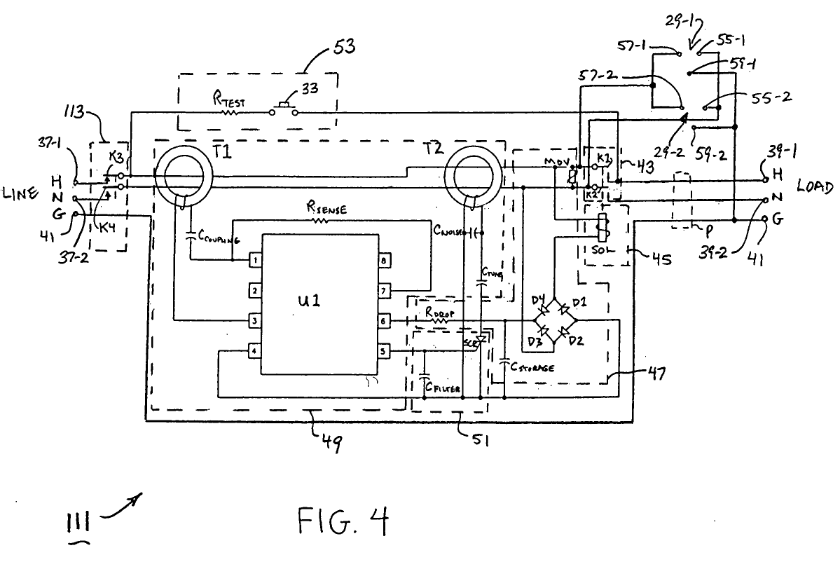

A plurality of externally accessible conductive terminals 37, 39 and 41 are provided which serve as connection points for coupling the power source, load and ground to GFCI 11. Terminals 37, 39 and 41 are coupled, at one end, to the GFCI electronics (shown in schematic form in FIG. 3) which are located within casing 13, the free end of each terminal 37, 39 and 41 extending out through a corresponding opening in casing 13 so as to render it externally accessible for connection thereto.

It should be noted that each of conductive terminals 37, 39 and 41 is represented herein as being in the form of a threaded metal screw which can be driven inward (e.g., using a screwdriver) to draw a conductive lead, or wire, into electrical contact against a metallic plate (not shown). However, it is to be understood that various alternative types of connection means (e.g., push-in wire receptacles) are commonly utilized to connect a GFCI to a load, line and/or ground.

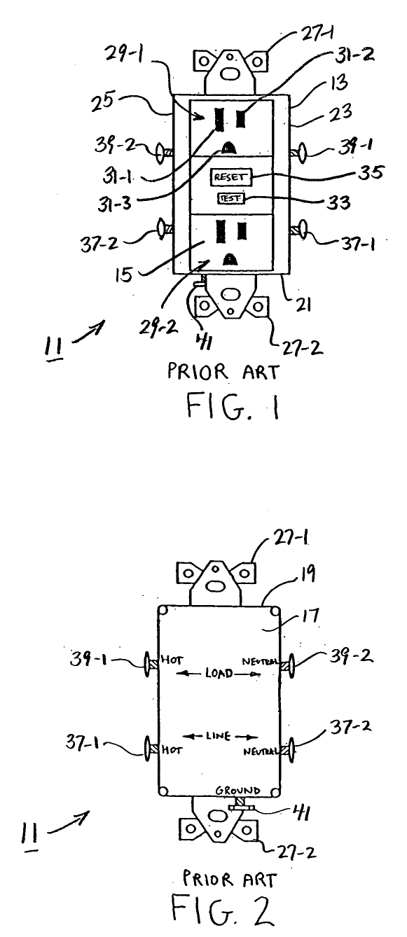

As seen most clearly in FIG. 2, conductive terminals 37 are designated as the line side terminals for GFCI 11. Specifically, conductive terminal 37-1 is designated for connection to the wire which leads to the hot line H of the power source. In addition, conductive terminal 37-2 is designated for connection to the wire which leads to the neutral line N of the power source. It should be noted that each of line side terminals 37 is identified on rear surface 17 to ensure proper connection thereto.

Conductive terminals 39 are designated as the load side terminals for GFCI 11. Specifically, conductive terminal 39-1 is designated for connection to the wire which leads to the hot line H of the load. In addition, conductive terminal 39-2 is designated for connection to the wire which leads to the neutral line N of the load. It should be noted that each of load side terminals 39 is identified on rear surface 17 to ensure proper connection thereto.

Conductive terminal 41 is designated as the ground terminal for GFCI 11. Specifically, conductive terminal 41 is designated for connection to the wire which leads to ground. It should be noted that, in order to ensure the proper connection to ground, conductive terminal 41 is often colored green (which is recognized in the industry as representing a ground connection) and rear surface 17 of casing 13 is also provided with a suitable identifying marker.

Referring now to FIG. 3, there is shown a simplified circuit diagram of GFCI 11. In this circuit diagram, GFCI 11 connects a load (identified in FIG. 3 as LOAD) to a power source (identified in FIG. 3 as LINE) through a hot line H, a neutral line N and a ground line G. In addition, GFCI 11 connects electrical outlets 29-1 and 29-2 to the power source through hot line H, neutral line N and ground line G. As will be described further below, GFCI 11 is provided with means for suspending the application of power from the power source to both the load and outlets 29 upon sensing the presence of a ground fault condition along lines H and N. It should be noted that the majority of the electrical components shown in FIG. 3 are housed within the interior of casing 13 and are mounted on a common double-sided printed circuit board (not shown).

GFCI 11 includes a circuit breaker 43 for controlling the delivery of power along conductive lines H and N from the power source to both the load and outlets 29, a relay circuit 45 for controlling the operation of the circuit breaker 43, a power supply circuit 47 for supplying power to selected electrical components in GFCI 11, a fault detection circuit 49 for sensing the presence of a ground fault condition in hot and neutral lines H and N, a latch circuit 51 for converting a fault condition signal produced by fault detection circuit 49 into the appropriate signal which can be used to regulate relay circuit 45, and a test circuit 53 for verifying that GFCI 11 is operating properly.

Circuit breaker 43 includes a pair of normally closed, single-pole, single-throw switches K1 and K2 which are located in hot and neutral conductive lines H and N, respectively, between the power source and the load (as well as between the power source and outlets 29). Switches K1 and K2 can be disposed in either of two positions: a first position in which switches K1 and K2 are open (as illustrated in FIG. 3), such that the supply of AC power is suspended from the power source to the load (as well as outlets 29); and a second position in which switches K1 and K2 are both closed, such that the supply of AC power from the power source is delivered to the load (as well as outlets 29).

Relay circuit 45 is responsible for controlling the connective position of switches K1 and K2. Specifically, relay circuit 45 includes a solenoid SOL that is ganged to the circuit breaker contacts of switches K1 and K2. Before power is applied to GFCI 11, solenoid SOL positions switches K1 and K2 in their second connective position (i.e., their closed positions). After power is applied to GFCI 11, solenoid SOL will retain switches K1 and K2 in their second connective positions (i.e., their closed positions). However, once solenoid SOL is energized, solenoid SOL moves switches to their first connective positions (i.e., their open positions).

Power supply circuit 47 supplies power to selected components in GFCI 11. Power supply circuit 47 comprises a metal oxide varistor MOV, four silicon controlled rectifiers D1, D2, D3 and D4, a voltage dropping resistor R_{DROP}, and a storage capacitor C_{STORAGE}. Varistor MOV helps to protect the load against a voltage surge from the AC power source. Rectifiers D1-D4 (each having a model number of 1N4004) together form a conventional diode rectifier bridge and serve to convert the alternating current (AC) power from the power source into direct current (DC) power. Voltage dropping resistor R_{DROP} has a value of 24 Kohms and acts to limit the input voltage to solenoid SOL to prevent inadvertent switching in circuit breaker 43. Storage capacitor C_{STORAGE} has a value of 0.01 uF and acts to charge to full line potential when reset button 35 is depressed.

Fault detection circuit 49 acts to detect the presence of ground fault conditions in conductive lines H and N when switches are disposed in their second connective position (i.e., their closed positions). Fault detection circuit 49 comprises a sense transformer T1, a grounded neutral transformer T2, a coupling capacitor C_{COUPLING}, a noise suppression capacitor C_{NOISE}, a tuning capacitor C_{TUNE}, a sense resistor R_{SENSE} and a ground fault interrupter chip U1. Sense transformer T1 senses the current differential between the hot and neutral conductive lines H and N, and upon the presence of a ground fault condition, transformer T1 induces an associated output from its secondary windings. Grounded neutral transformer T2 acts in conjunction with transformer T1 to sense the presence of grounded neutral conditions and, in turn, induce an associated output. Coupling capacitor C_{COUPLING} has a value of 10 uF and acts to couple the alternating current signal from the secondary winding of sense transformer T1 to chip U1. Noise suppression capacitor C_{NOISE} has a value of 0.01 uF and acts to prevent fault detection circuit 49 from operating in response to line disturbances such as electrical noise and lower level faults. Tuning capacitor C_{TUNE} has a value of 0.03 uF and sense resistor R_{SENSE} has a value of 1.0 Mohms. Together tuning capacitor C_{TUNE} and sense resistor R_{SENSE} act to set the minimum fault current at which fault detection circuit 49 provides an output signal to latch circuit 51. Interrupter chip U1 is an RV4145 low power ground fault interrupter circuit which is sold by Raytheon Corporation. Chip U1 serves to amplify the fault signal generated by sense transformer T1 and provide an output, or trigger, pulse (at pin 5) to activate latch circuit 51.

Latch circuit 51 acts to take the electrical signal produced by fault detection circuit 49 (i.e., at output pin 5) upon the detection of a ground fault condition and, in turn, energize solenoid SOL. Latch circuit 51 comprises a silicon controlled rectifier SCR which is operable in either a conductive or non-conductive state and a filter capacitor C_{FILTER}. Preferably, reset switch 35 is provided as part of latch circuit 51 and is connected at one end to the anode of rectifier SCR and at the other end to the cathode of rectifier SCR (although reset switch 35 is not shown in the schematic shown in FIG. 3). Rectifier SCR is an EC103D rectifier sold by Teccor Corporation and acts to selectively control the state of solenoid SOL. Filter capacitor C_{FILTER} has a value of 2.2 uF and acts in preventing rectifier SCR from producing a signal as a result of electrical noise in GFCI 11.

Test circuit 53 provides a means of testing whether GFCI 11 is operating properly. Test circuit 53 comprises a current limiting resistor R_{TEST} having a value of 15 Kohms and test switch 33 (which is of the conventional push-in type design). When test switch 33 is depressed to energize test circuit 53, resistor R_{TEST} provides a simulated fault current to sense transformer T1 which is similar to a ground fault condition.

Outlets 29-1 and 29-2 are connected to hot and neutral conductive lines H and N at a location between circuit breaker 43 and load-side terminals 39. Specifically, each outlet 29 includes a neutral line conductive terminal 55 which is connected to neutral line N at a location between terminal 39-2 and switch K2, each conductive terminal 55 being externally accessible through a corresponding opening 31-1 in casing 13. Similarly, each outlet 29 includes a hot line conductive terminal 57 which is connected to hot line H at a location between terminal 39-1 and switch K1, each conductive terminal 57 being externally accessible through a corresponding opening 31-2 in casing 13. Furthermore, each outlet 29 includes a ground terminal 59 which is connected to ground G, each ground terminal 59 being externally accessible through a corresponding opening 31-3 in casing 13.

As noted above, GFCI 11 connects a power source (represented as LINE in FIG. 3) to both a load (represented as LOAD in FIG. 3) and electrical outlets 29 through a plurality of conductive lines (represented as H, N and G in FIG. 3) and, in addition, provides both the load and outlets 29 with protection against ground fault conditions that are present along the conductive lines. It is essential to note that GFCI 11 is constructed with line side terminals 37 designated to receive the power source and load side terminals 39 designated to receive the load.

With the power source connected to line side terminals 37 and the load connected to load side terminals 39, GFCI 11 operates in the following manner. In the absence of a ground fault condition, switches K1 and K2 are disposed in their closed positions, thereby enabling AC power to pass from the power source (i.e., LINE) to both the load and outlets 29 through hot and neutral conductive lines H and N.

As alternating current (AC) power is being supplied from the power source to the load and outlets 29, fault detection circuit 49 monitors the conductive lines for the presence of a ground fault condition (i.e., unequal current values along hot and neutral lines H and N). If a ground fault condition is detected along the conductive lines (or upon the depression of test button 33), fault detection circuit 49 sends a signal to latch circuit 51 which, in turn, energizes solenoid SOL. The activation of solenoid SOL causes switches K1 and K2 (which are ganged together to solenoid SOL) to open. With switches K1 and K2 open, the potentially dangerous ground fault condition present along hot and neutral lines H and N (in particular, between line side terminals 37 and circuit breaker 43) is unable to pass onto the load or electrical outlets 29. In this manner, the load as well as outlets 29 are protected against receiving the ground fault condition from the power source, which is highly desirable. Once the fault condition is eliminated, GFCI 11 can be reset through the depression of reset button 35 which, in turn, causes solenoid SOL to return switches K1 and K2 to their closed positions.

Although rear surface 17 of casing 13 is provided with markings to facilitate proper connection, it has nonetheless be found that, on occasion, consumers incorrectly connect the power source and load to the GFCI 11. Specifically, consumers often inadvertently connect the cables leading to the power source (i.e., the line side cables) to load side terminals 39 and the cables leading to the load (i.e., the load side cables) to line side terminals 37. This inadvertent wiring mistake still enables the power source to supply voltage to both the load and outlets 29 through conductive lines H and N when switches K1 and K2 are in their closed positions. In addition, this inadvertent wiring mistake does not compromise the ability of GFCI 11 to provide the load with ground fault protection. However, with the power source and load coupled to GFCI 11 in this manner, it should be noted that outlets 29 are not provided with ground fault protection, which is highly undesirable.

Specifically, power is supplied from the power source via load side terminals 39 to the load via line side terminals 37. The power supplied by the power source travels through circuit breaker 43 and is ultimately measured by fault detection circuit 49. When a ground fault condition is detected along conductive lines H and N by fault detection circuit 49, solenoid SOL opens switches K1 and K2 of circuit breaker 43, thereby suspending further application of power from the power source to the load.

However, it should be noted that opening switches K1 and K2 does not serve to protect electrical outlets 29 from the ground fault condition in the conductive lines. Rather, with switches K1 and K2 open, any ground fault condition in the conductive lines that is derived from the power source will still pass into outlets 29. As a result, even though switches K1 and K2 have been opened in response to the detection of a ground fault condition, a closed circuit remains between outlets 29 and the power source and, accordingly, any current imbalance (as well as any resulting current surge) present along the conductive lines at the power source will flow into outlets 29. Accordingly, any electrical appliance which in is connected to outlets 29 remains susceptible to potentially dangerous electrical shock conditions, which is highly undesirable.

It is important to note that, with the load and power source improperly wired to GFCI 11 as set forth above, the consumer would be unaware of the lack of ground fault protection being provided to outlets 29. Specifically, in the absence of a ground fault condition, the load and outlets 29 would receive power from the power source as if the connections were proper. In addition, test button 33 and reset button 35 would operate as if GFCI 11 were properly wired. As a result, a consumer may power an electrical appliance through outlets 29 with the understanding that the appliance is being provided with ground fault protection when, in fact, GFCI 11 is providing no ground fault protection to the appliance.

It is for the reasons enumerated above that prior art GFCI 11 is identified herein as providing ground fault protection in only one direction. Specifically, GFCI 11 provides ground fault protection to outlets 29 in only the direction from line side terminals 37 to load side terminals 39. However, GFCI 11 does not provide ground fault protection to outlets 29 in the opposite direction (i.e., in the direction from load side terminals 39 to line side terminals 37), which is highly undesirable.

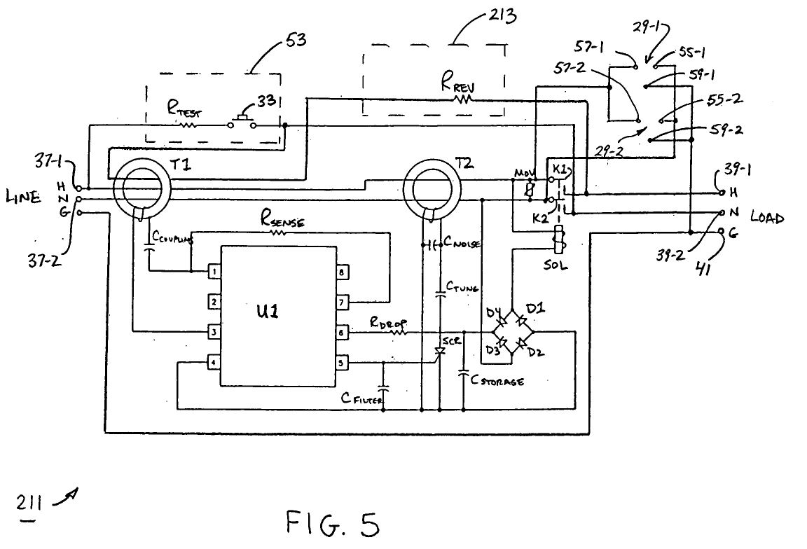

Accordingly, referring now to FIG. 4, there is shown a first embodiment of a ground fault circuit interrupter (GFCI) which is constructed according to the teachings of the present invention, the GFCI being identified generally by reference numeral 111. As will be described further below, GFCI 111 differs from prior art GFCI 11 in that GFCI 111 provides ground fault protection to outlets 29 in two directions (i.e., in either direction between terminals 37 and 39) whereas prior art GFCI 11 provides ground fault protection to outlets 29 in only one direction (i.e., in the direction from terminals 37 to terminals 39).

GFCI 111 is identical in all respects with GFCI 11 with two notable distinctions.

As a first notable distinction of GFCI 111 in view of GFCI 11, it should be noted that GFCI 111 includes a second circuit breaker 113 for controlling the delivery of power along conductive lines H and N from the power source to the load. Circuit breaker 113 includes a pair of normally closed, single-pole, single-throw switches K3 and K4 which are located in hot and neutral conductive lines H and N, respectively, between line side terminals 37 and circuit breaker 43, with circuit breaker 43 located in hot and neutral conductive lines H and N, respectively between circuit breaker 113 and load side terminals 39. Switches K1, K2, K3 and K4 are all ganged together to solenoid SOL. As a result, with solenoid SOL deactivated, switches K1, K2, K3 and K4 are all disposed in their closed positions. To the contrary, with solenoid SOL activated, switches K1, K2, K3 and K4 are all disposed in their open positions.

As a second notable distinction of GFCI 111 in view of GFCI 11, it should be noted that outlets 29 in GFCI 111 are connected to conductive lines H and N of the power cord at a location between circuit breaker 43 and circuit breaker 113 (whereas outlets 29 in GFCI 11 are connected to conductive lines H and N at a location between circuit breaker 43 and load side terminals 39). Specifically, each outlet 29 includes a neutral line conductive terminal 55 which is connected to neutral line N at a location between circuit breakers 43 and 113 and a hot line conductive terminal 57 which is connected to hot line H at a location between circuit breakers 43 and 113.

As can be appreciated, the two distinctions noted above provide GFCI 111 with the ability to protect outlets 29 from ground fault conditions in either of two directions (i.e., regardless of whether the power source is connected to line side terminals 37 or load side terminals 39). Specifically, with the power source connected to line side terminals 37 and the load connected to load side terminals 39 (i.e., in the proper manner as designated), GFCI 111 operates in the following manner. In the absence of a ground fault condition, switches K1, K2, K3 and K4 are all closed, thereby enabling AC power to pass from the power source to both outlets 29 and the load. If a ground fault condition is detected along the conductive lines, solenoid SOL opens switches K1, K2, K3 and K4. With switches K1 and K2 open, the load is electrically disconnected from the power source and, as a consequence, the ground fault condition. Further, with switches K3 and K4 open, outlets 29 are electrically disconnected from the power source and, as a consequence, the ground fault condition. In this manner, GFCI 111 protects both the load and outlets 29 from the ground fault condition, which is highly desirable.

With the power source connected to load side terminals 39 and the load connected to line side terminals 37 (i.e., in the reverse manner as designated), GFCI 111 operates in the following manner. In the absence of a ground fault condition, switches K1, K2, K3 and K4 are all closed, thereby enabling AC power to pass from the power source (located at load side terminals 39) to both the load (located at line side terminals 37) and outlets 29. If a ground fault condition is detected along the conductive lines, solenoid SOL opens switches K1, K2, K3 and K4. With switches K3 and K4 open, the load is electrically disconnected from the power source and, as a consequence, the ground fault condition. Further, with switches K1 and K2 open, outlets 29 are electrically disconnected from the power source and, as a consequence, the ground fault condition. In this manner, GFCI 111 protects both the load and outlets 29 from the ground fault condition in two directions, which is a principal object of the present invention.

It should be noted that the bi-directional ground fault protection afforded to outlets 29 (as well as the load) by GFCI 111 means that it is no longer necessary for terminals 37 and 39 to be designated for a particular connection (e.g., to the load or power source). As a result, the consumer is afforded greater flexibility during the connection process, which is highly desirable.

Referring now to FIG. 5, there is shown a second embodiment of a ground fault circuit interrupter (GFCI) which is constructed according to the teachings of the present invention, the GFCI being identified generally by reference numeral 211. As will be described further below, GFCI 211 differs from prior art GFCI 11 in that GFCI 211 provides ground fault protection to outlets 29 in two directions (i.e., in either direction between terminals 37 and 39) whereas prior art GFCI 11 provides ground fault protection to outlets 29 in only one direction (i.e., in the direction from terminals 37 to terminals 39).

GFCI 211 is identical in all respects with GFCI 11 with two notable distinctions.

As a first notable distinction of GFCI 211 in view of GFCI 11, it should be noted that outlets 29 in GFCI 211 are connected to conductive lines H and N of the power cord at a location between circuit breaker 43 and line side terminals 37 (whereas outlets 29 in GFCI 11 are connected to conductive lines H and N at a location between circuit breaker 43 and load side terminals 39). Specifically, each outlet 29 includes a neutral line conductive terminal 55 which is connected to neutral line N at a location between switch K2 and line side terminal 37-2 and a hot line conductive terminal 57 which is connected to hot line H at a location between switch K1 and line side terminal 37-1.

As a second notable distinction of GFCI 211 in view of GFCI 11, it should be noted that GFCI 211 includes a reverse wiring circuit 213 for generating an artificial ground fault condition (which, in turn, trips GFCI 211) when the power source and the load are connected to GFCI 211 in the reverse order, as will be described further below. Reverse wiring circuit 213 includes a reverse wiring resistor R_{REV} (having a value preferably in the range of 68470 ohms). Reverse wiring resistor R_{REV} extends through sense transformer T1 and is connected at one end to test circuit 53 and is connected at its other end to load side terminal 39-1.

As can be appreciated, the two distinctions noted above provide GFCI 211 with the ability to protect outlets 29 from ground fault conditions in either of two directions (i.e., regardless of whether the power source is connected to line side terminals 37 or load side terminals 39). With the power source connected to line side terminals 37 and the load connected to load side terminals 39 (i.e., in the proper manner as designated), GFCI 211 operates in a similar manner as GFCI 11. Specifically, in the absence of a ground fault condition, switches K1 and K2 remain closed, thereby enabling AC power to pass from the power source to both the load (at load side terminals 39) and outlets 29. It should be noted that test switch 33 is normally open, thereby precluding reverse wiring resistor R_{REV} from producing a signal that can be detected by sense transformer T1 as an artificial ground fault condition. If a true ground fault condition is detected along the conductive lines of the power cord, solenoid SOL opens switches K1 and K2. With switches K1 and K2 open, the load as well as outlets 29 are electrically disconnected from the power source and, as a consequence, the ground fault condition. In this manner, GFCI 211 protects both the load and outlets 29 from the ground fault condition, which is highly desirable.

However, it should be noted that GFCI 211 operates differently than GFCI 11 when the power source is connected to load side terminals 39 and the load is connected to line side terminals 37 (i.e., in the reverse manner as designated). Specifically, by wiring the power source to load side terminals 39, a current is supplied directly into reverse wiring resistor R_{REV} which, in turn, causes sense transformer T1 to detect the presence of a current imbalance in the conductive lines. In response thereto, solenoid SOL opens switches K1 and K2. With switches K1 and K2 open, the load and outlets 29 are electrically disconnected from the power source and, as a result, any appliance connected thereto will not receive power. In this sense, the current which passes through reverse wiring resistor R_{REV} acts as an artificial fault condition which, in turn, suspends the application of power from the power source to both the load and outlets 29. With GFCI 211 tripped open upon the detection of this artificial fault condition, it is to be understood that any future depression of reset button 35 will immediately cause reverse wiring circuit 213 to generate another artificial signal to trip open GFCI 211 once again. In fact, GFCI 211 will continue to trip open every time reset button 35 is depressed. As a result, the load and outlets 29 will never be supplied the unprotected power from the power source until the connection of GFCI 211 to the power source and the load are made proper.

It should be noted that, if GFCI 211 is wired properly, the first application of power through hot and neutral conductive lines H and N will ultimately travel through reverse wiring resistor R_{REV}. Due to the relatively small resistance of reverse wiring resistor R_{REV} (i.e., in the range of approximately 68-470 ohms), the reverse wiring resistor R_{REV} will instantly overheat and burn out upon the first application of power through the hot and neutral line terminals. Once the reverse wiring resistor R_{REV} burns out, that portion of the circuit is rendered inoperable and GFCI 211 operates normally as described in detail above.

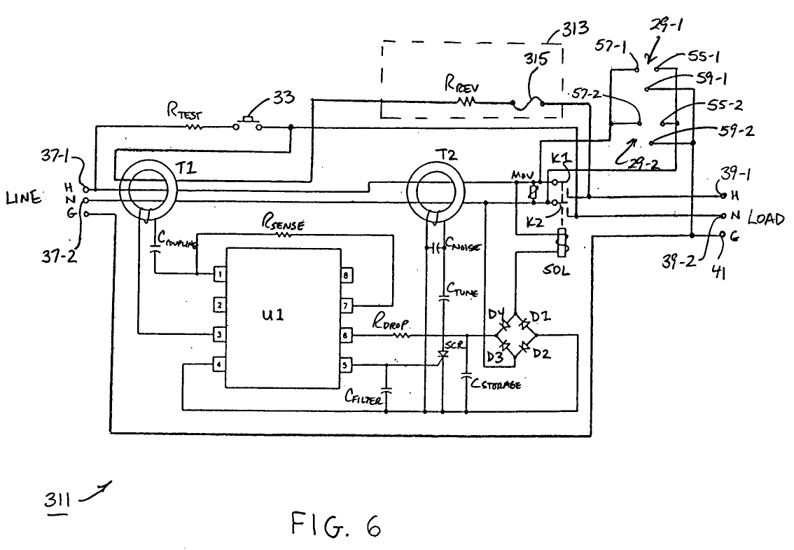

Referring now to FIG. 6, there is shown a third embodiment of a ground fault circuit interrupter (GFCI) which is constructed according to the teachings of the present invention, the GFCI being identified generally by reference numeral 311. As can be appreciated, GFCI 311 operates in a similar manner as GFCI 211. As such, it is to be understood that GFCI 311 functions by (1) providing ground fault protection to outlets 29 when the power source and load are connected to GFCI 311 in a proper manner and (2) maintaining GFCI 311 in a tripped condition (i.e., suspending the application of power from the line to the load and outlets 29) when the power source and load are connected to GFCI 311 in the reverse order.

The sole distinction between GFCI 311 and GFCI 211 relates to the fact that GFCI 311 includes a reverse wiring circuit 313 which differs slightly in construction from reverse wiring circuit 213 in GFCI 211. Specifically, reverse wiring circuit 313 is similar to reverse wiring circuit 213 in that reverse wiring circuit 313 includes a reverse wiring resistor R_{REV} which extends through sense transformer T1 and is connected at one end to test circuit 53 and is connected at its other end to load side terminal 39-1. However, reverse wiring circuit 313 differs from reverse wiring circuit 213 in that reverse wiring circuit 313 additionally includes a fuse 315 which is connected in series with reverse wiring resistor R_{REV}. It is to be understood that fuse 315 is provided in reverse wiring circuit 313 to facilitate the opening (i.e., burning out) process of reverse wiring circuit 313 when GFCI 311 is wired properly.

The versions of the present invention described above are intended to be merely exemplary and those skilled in the art shall be able to make numerous variations and modifications to it without departing from the spirit of the present invention. For example, although the majority of the fireguard circuits described in detail above are shown for use as a safety device for a power cable which comprises three conducting lines, it is to be understood that these fireguard circuits could also be used as a safety device for a power cable which comprises two conducting lines without departing from the spirit of the present invention. All such variations and modifications are intended to be within the scope of the present invention as defined in the appended claims. For example, it should be noted that the particular components which make up the aforementioned embodiments may be interchanged or combined to form additional embodiments.

1. A ground fault circuit interrupter (GFCI) for use with a power cable, the power cable being designed to connect a power source with a load, the power cable comprising at least a hot line and a neutral line, the ground fault circuit interrupter comprising:
(a) a first pair of terminals located at one end of the power cable,
(b) a second pair of terminals located at the other end of the power cable,
(c) an electrical outlet connected to the power cable at a location between the first and second pairs of terminals,
(d) a first circuit breaker having a first switch, the first switch being located in one of the lines of the power cable between the first pair of terminals and the electrical outlet, the first switch having an open position and a closed position,
(e) a second circuit breaker having a second switch, the second switch being located in one of the lines of the power cable between the electrical outlet and the second pair of terminals, the second switch having an open position and a closed position, the first and second switches being ganged together,
(f) a relay circuit for selectively moving and maintaining each of the first and second switches in either its open position or its closed position, and
(g) a ground fault detection circuit for detecting the presence of a ground fault condition in the power cable between the first and second pairs of terminals, the ground fault detection circuit providing a trip signal upon detecting a ground fault condition in the power cable, the relay circuit moving and maintaining each of the first and second switches in its open position in response to the trip signal.

2. The GFCI as claimed in claim 1 wherein one of the first pair of terminals is located in the hot line and the other of the first pair of terminals is located in the neutral line.

3. The GFCI as claimed in claim 2 wherein one of the second pair of terminals is located in the hot line and the other of the second pair of terminals is located in the neutral line.

4. The GFCI as claimed in claim 3 wherein the first circuit breaker includes a first pair of switches located in the power cable between the first pair of terminals and the electrical outlet, one switch being located in the hot line and the other switch being located in the neutral line, the first pair of switches being ganged together.

5. The GFCI as claimed in claim 4 wherein the second circuit breaker includes a second pair of switches located in the power cable between the electrical outlet and the second pair of terminals, one switch being located in the hot line and the other switch being located in the neutral line, the second pair of switches being ganged together.

6. The GFCI as claimed in claim 5 wherein the relay circuit includes a solenoid which is ganged to the pair of switches in each of the first and second circuit breakers.

7. The GFCI as claimed in claim 6 further comprising a test circuit, the test circuit being connected at one end to the hot line at the first pair of terminals and at the other end to the hot line at the second pair of terminals, the test circuit comprising a normally open test switch.

8. A ground fault circuit interrupter (GFCI) for use with a power cable, the power cable being designed to connect a power source with a load, the power cable comprising at least a hot line and a neutral line, the ground fault circuit interrupter comprising:
(a) a first pair of terminals located at one end of the power cable, the first pair of terminals being designated for connection to the power source,
(b) a second pair of terminals located at the other end of the power cable, the second pair of terminals being designated for connection to the load,
(c) an electrical outlet connected to the power cable at a location between the first and second pairs of terminals,
(d) a circuit breaker having a first switch, the first switch being located in one of the lines of the power cable between the first pair of terminals and the electrical outlet, the first switch having an open position and a closed position,
(e) a relay circuit for selectively moving and maintaining the first switch in either its open position or its closed position,
(f) a reverse wiring circuit for generating an artificial ground fault condition when the power source is connected to the second pair of terminals, and
(g) a ground fault detection circuit for detecting the presence of either a ground fault condition in the power cable between the first and second pairs of terminals or an artificial ground fault condition generated by the reverse wiring circuit, the ground fault detection circuit providing a trip signal upon detecting either the ground fault condition or the artificial ground fault condition, the relay circuit moving and maintaining the first switch in its open position in response to the trip signal.

9. The GFCI as claimed in claim 8 wherein one of the first pair of terminals is located in the hot line and the other of the first pair of terminals is located in the neutral line.

10. The GFCI as claimed in claim 9 wherein one of the second pair of terminals is located in the hot line and the other of the second pair of terminals is located in the neutral line.

11. The GFCI as claimed in claim 10 wherein the circuit breaker includes a first pair of switches located in the power cable between the first pair of terminals and the electrical outlet, one switch being located in the hot line and the other switch being located in the neutral line, the first pair of switches being ganged together.

12. The GFCI as claimed in claim 11 wherein the relay circuit includes a solenoid which is ganged to the first pair of switches in the circuit breaker.

13. The GFCI as claimed in claim 8 wherein the ground fault detection circuit comprises a sense transformer which senses any current differential present between the hot and neutral lines.

14. The GFCI as claimed in claim 13 wherein the reverse wiring circuit extends through the sense transformer for the ground fault detection circuit.

15. The GFCI as claimed in claim 14 further comprising a test circuit, the test circuit being connected at one end to the hot line at the first pair of terminals and at the other end to the hot line at the second pair of terminals, the test circuit comprising a normally open test switch.

16. The GFCI as claimed in claim 15 wherein the reverse wiring circuit is connected at one end to the test circuit and is connected at the other end to the power cable at the second pair of terminals.

17. The GFCI as claimed in claim 16 wherein the reverse wiring circuit includes a reverse wiring resistor.

18. The GFCI as claimed in claim 17 wherein the reverse wiring resistor has a value which is the range between 68 ohms and 470 ohms.

19. The GFCI as claimed in claim 17 wherein the reverse wiring circuit additionally includes a fuse connected in series with the reverse wiring resistor.

20. A ground fault circuit interrupter for use with a power cable, said power cable connecting a power source with a load, said power cable comprising at least a hot line and a neutral line, said ground fault circuit interrupter comprising:
(a) a first pair of terminals located at one end of the power cable,
(b) a second pair of terminals located at the other end of the power cable,
(c) an electrical outlet connected to the power cable at a location between the first and second pairs of terminals,
(d) a first circuit breaker having a first switch, the first switch being located in one of the lines of the power cable between the first and second pairs of terminals, the first switch having an open position and a closed position,
(e) a relay circuit for selectively moving and maintaining the first switch in either its open position or its closed position, and
(f) a ground fault detection circuit for detecting the presence of a ground fault condition in the power cable between the first and second pairs of terminals, the ground fault detection circuit providing a trip signal to the relay circuit upon detecting a ground fault condition in the power cable, the relay circuit moving and maintaining the first switch in its open position in response to receiving the trip signal, and
(g) wherein the ground fault detection circuit provides bi-directional ground fault protection to the electrical outlet between the first and second pairs of terminals.
